(19) United States
(12) Patent Application Publication
(10) Pub. No.: US 2021/0289178 A1
(43) Pub. Date: Sep. 16, 2021

(54) PROJECTOR SYSTEM WITH BUILT-IN MOTION SENSORS

(71) Applicants: Sony Interactive Entertainment LLC, San Mateo, CA (US); Sony Interactive Entertainment Inc., Tokyo (JP)

(72) Inventors: Naoki Ogishita, San Mateo, CA (US); Udupi Ramanath Bhat, San Mateo, CA (US); Yasushi Okumura, San Mateo, CA (US); Marina Villanueva-Barreiro, San Mateo, CA (US)

(21) Appl. No.: 16/816,637

(22) Filed: Mar. 12, 2020

(51) Int. Cl. H04N 9/31

(52) U.S. Cl. CPC H04N 9/3147

(57) ABSTRACT

A projector system includes two free-standing, upright projector housings between which a person can be positioned and can be imaged by one or more sensors on each housing. A projector on each housing projects an avatar of the person onto a wall between the projector housings so that the person can view his avatar.

### FIELD

The application relates generally to projector systems with built-in motion sensors.

### BACKGROUND

As understood herein, people who are interested in a physical activity such as golf or yoga can obtain guidance on proper technique using software applications executed by their personal computer or tablet computer or smart phone. Commonly-owned U.S. patent application Ser. No. 16/692,752, filed Nov. 22, 2019 and incorporated herein by reference, provides a system that obtains video images of a person undertaking a physical activity such as yoga and compares the physical activity against a ground truth representation to output a comparison that the person can view in real time to help the person improve.

### SUMMARY

Accordingly, present principles provide a projector system with various sensors to capture images of the person undertaking the physical activity and to project onto, for example, a wall images showing an avatar of the person along with a ground truth representation of the correct motion in the form of a virtual “coach”.

In a first aspect, an assembly includes at least a first elongated projector housing. The projector housing, in some examples, may be a free-standing housing that is oriented vertically. The assembly includes at least a first sensor on the first elongated projector housing to generate a signal representative of a person, and at least a first projector on the first elongated projector housing and configured to project an avatar of the person onto a surface so that the person can view the avatar side by side with a ground truth image.

In some implementations, the assembly may include at least a second elongated projector housing. At least a second sensor may be on the second elongated projector housing to generate a signal representative of the person, while at least a second projector also may be on the second elongated projector housing and configured to project images onto the surface juxtaposed with images from the first projector.

In example embodiments the first elongated projector housing includes plural elongated louvers oriented vertically. The first sensor can be disposed between first and second louvers of the plural elongated louvers, or it may be disposed on at least one of the plural elongated louvers. If desired, the first sensor can be disposed on a rotatable upper segment of the first elongated projector housing.

In non-limiting implementations the first sensor may include at least one event-driven sensor (EDS), and/or at least one red-green-blue (RGB) camera, and/or at least one depth sensor, and/or at least one microphone. At least one speaker may be on the first housing.

In an example embodiment, the assembly may include at least one processor programmed with instructions to identify that a projection from the first projector overlaps with a projection from the second projector, and responsive to identifying that the projection from the first projector overlaps with the projection from the second projector, alter at least one of the projections.

In another aspect, an assembly includes at least a first projector housing, at least a first projector on the first projector housing and configured to project images onto a surface, and plural elongated louvers oriented parallel to each other on the first projector housing.

In another aspect, a method includes imaging a person using at least one sensor on a housing and projecting an avatar of the person based on output of the sensor onto a surface using at least one projector on the housing.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 illustrates an example dual-projector assembly consistent with present principles, showing a person whose image is captured and rendered into a projected avatar next to a ground truth “coach” avatar;

FIG. 2 illustrates details of a top portion one of the projectors in FIG. 1;

FIGS. 3-6 illustrate example shapes of a projector;

FIG. 7 illustrates another example dual-projector assembly;

FIG. 8 illustrates an example tiltable speaker assembly;

FIGS. 9 and 9A illustrate a flow chart of example logic consistent with present principles;

FIGS. 10-12 illustrate principles attendant to FIGS. 9 and 9A;

FIG. 13 illustrates a top portion of an alternate projector assembly;

FIGS. 14-18 further illustrate projector calibration; and

FIGS. 19 and 20 further illustrate camera calibration.

### DETAILED DESCRIPTION

This disclosure relates generally to computer ecosystems including aspects of consumer electronics (CE) device networks such as but not limited to computer simulation networks such as computer game networks as well as standalone computer simulation systems. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/ or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The above-incorporated U.S. patent application sets forth details of electrical and processing components that may be used in any of the devices discussed herein, in addition to or in connection with those components explicitly discussed.

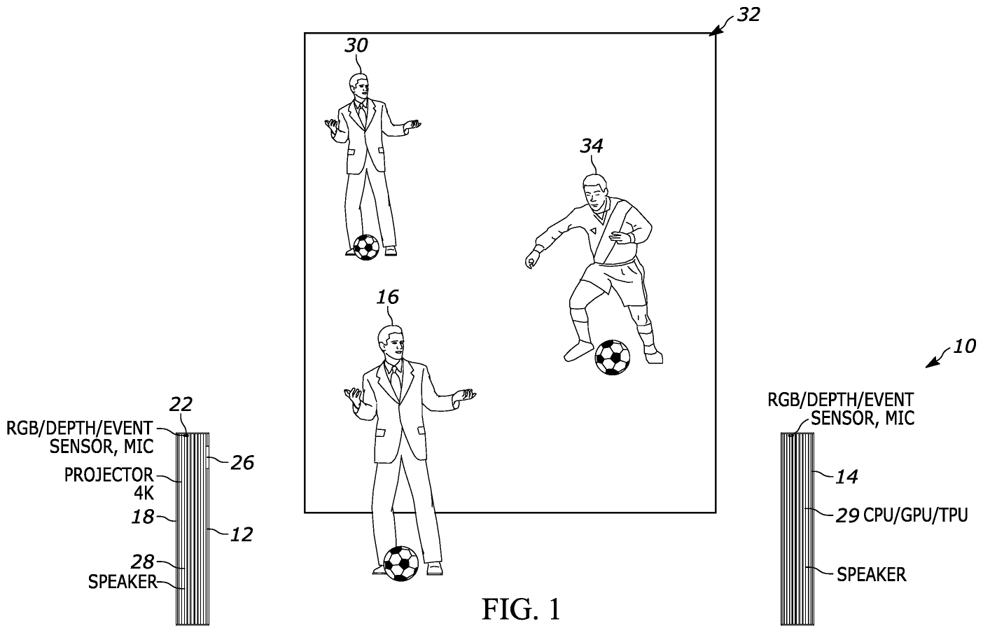

Now specifically referring to FIG. 1, an example assembly 10 is shown. The example assembly 10 includes a first elongated projector housing 12 and if desired a second projector housing 14 between which a person 16 can stand. As shown, the projector housings 12, 14 are free-standing housings oriented vertically and may be substantially identical to each other in configuration and operation except for any differences noted below.

As can be appreciated in reference to FIG. 1, each housing 12, 14 can include plural elongated co-parallel vertically oriented louvers 18 that may be made of wood or other material such as plastic or metal. The louvers 18 in the example shown are arranged around the complete circumference of the housing 12. Each louver 18 may be parallelepiped in cross-sectional shape and may extend from the bottom to the top of the housing 12. The louvers 18 may be movable on the housing 12 or may be stationary. The housing may be made of perforated metal and if desired may or may not include louvers.

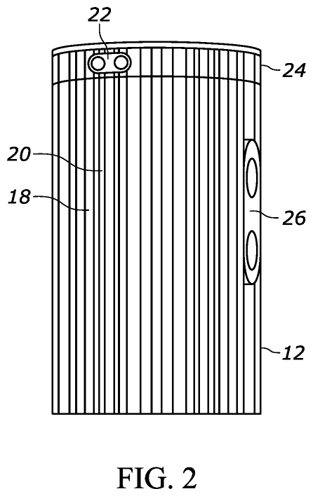

As perhaps best shown in FIG. 2, between adjacent louvers 18 are respective recessed 20. Thus, in the example shown, the louvers 18 are spaced from each other by the width of the recess 20.

Focusing on the first projector housing 12 and referring to FIGS. 1 and 2, at least one and in some instances plural sensors 22 may be supported on the housing 12. In the example shown, the sensors 22 are disposed on at least one of the louvers 18. Referring briefly to FIG. 13, the sensors 22 alternatively may be disposed between adjacent louvers 18 in a recess 20. Likewise, the lens of the below-described projector 26 may be disposed between adjacent louvers 18 in a recess 20.

The sensors 22 may include one or more of the following, including any combinations thereof: event-driven sensors (EDS), red-green-blue (RGB) cameras, depth sensors such as laser-based sensors, and microphones. An EDS typically includes sensing cells which detect motion by virtue of EDS principles. EDS uses the change of light intensity as sensed by one or more pixels as an indication of motion. Thus, an EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

Returning to FIGS. 1 and 2, the sensors 22 may be mounted on a rotatable upper segment 24 of the projector housing 12. Furthermore, the upper segment 24 may be tiltable in vertical dimension to adjust it for more optimal capturing in the field of view (FOV) region, recognizing that the quality of some sensors is better in the center than on the external edges. At least one projector 26 can be mounted on the housing 12 below the rotatable upper segment 24 but still nearer the top of the housing 12 than the bottom. The portion of the housing on which the projector 26 is mounted may be stationary or rotatable. The example projector 26 in FIGS. 1 and 2 may be a 4K projector.

If desired, below the projector 26 the housing 12 may support at least one audio speaker 28. In the example shown, the speaker 28 is located nearer the bottom of the housing 12 than the top of the housing.

One or both housings 12, 14 may include one or more processors including one or more central processing units (CPU), one or more graphics processing units (GPU), and one or more tensor processing units (TPU) to support machine learning as described in the referenced patent application. The processors may communicate with external components via one or more wireless transceivers such as described in the referenced patent application. In the non-limiting example shown, one or more processors 29 are in the second housing 14, and no projector is on the second housing.

As may now be appreciated in reference to FIG. 1, the sensor(s) 22 of at least the housing 12 may generate images or other signals representative of the person 16, render the signals into an avatar 30 of the person, and then the projector 26 projects the avatar 30 onto a surface 32 such as a vertical wall. When the second housing contains a projector, it likewise may project an image of an avatar of the person onto the surface 32. As also described in the referenced application, an image 34 of ground truth, in the example shown, a “coach” in a correct pose that the person 16 attempts to mimic in a correct manner, may also be projected onto the surface 32 by the projector 26. The person 16 thus can stand between the housings 12, 14 in front of the surface 32 and view his avatar 30 and compare it with the ground truth image 34.

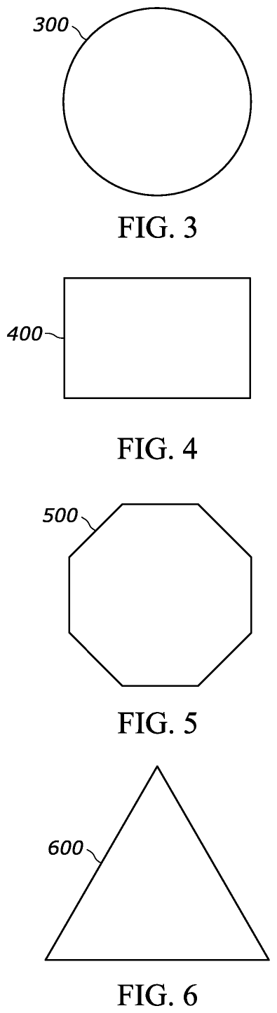

FIGS. 1 and 2 illustrate housings 12, 14 that are circular in transverse cross-section. FIG. 3 illustrates at 300 such a circular transverse cross-section. FIG. 4 illustrates at 400 a rectilinear transverse cross-section, FIG. 5 illustrates at 500 an octagonal transverse cross-section, and FIG. 6 illustrates at 600 a triangular transverse cross-section. The housings 12, 14 may have such transverse cross-sections as well as other suitable cross-sections, e.g., ovular or hexagonal, to name but two more examples.

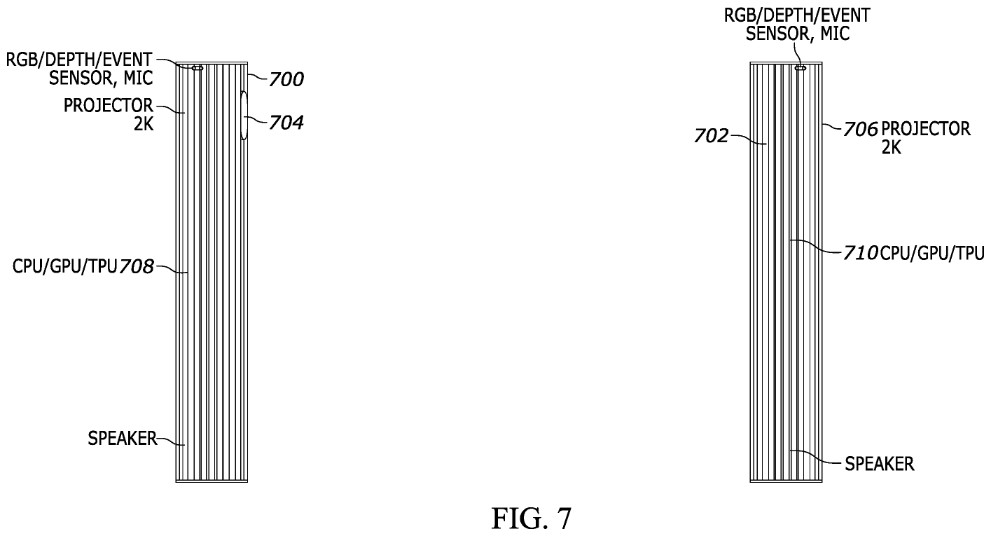

FIG. 7 illustrates two projector housings 700, 702 that in all essential respects are identical in configuration and operation to the housings 12, 14 in FIG. 1 with the following exceptions. Both projector housings 700, 702 shown in FIG. 7 may include respective projectors 704, 706 and in the example shown the projectors 704, 706 may be 2K projectors. Also, both projector housings 700, 702 shown in FIG. 7 may include respective combinations 708, 710 of one or more of CPUs/GPUs/TPUs.

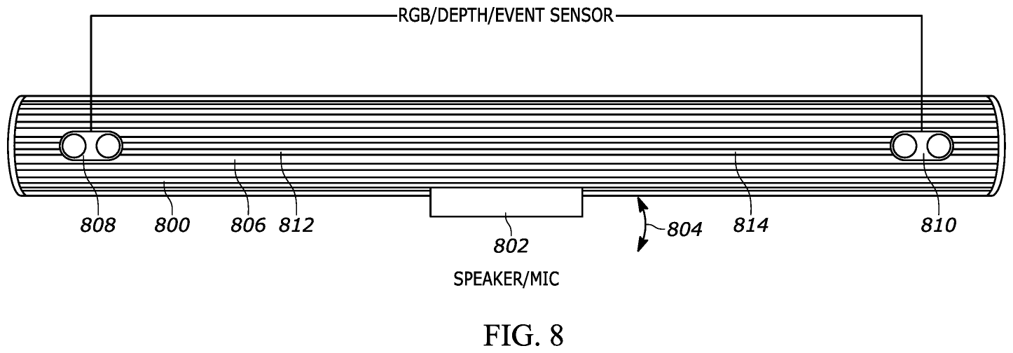

FIG. 8 illustrates an elongated housing 800 that may be oriented horizontally as shown on a tilt base 802 to permit the housing 800 to be tilted as indicated by the arrows 804. As was the case with the housings described above, the housing 800 shown in FIG. 8 may include plural louvers 806 that are parallel to each other and closely spaced from each other, extending end to end and along the entire circumference of the housing 800. Near each end of the housing 800, sensors 808, 810 may be respectively mounted. Any of the sensors described herein and combinations thereof may be mounted on the housing 800. The housing 800 may internally include one or more speakers and one or more microphones, as indicated at 812, 814 respectively.

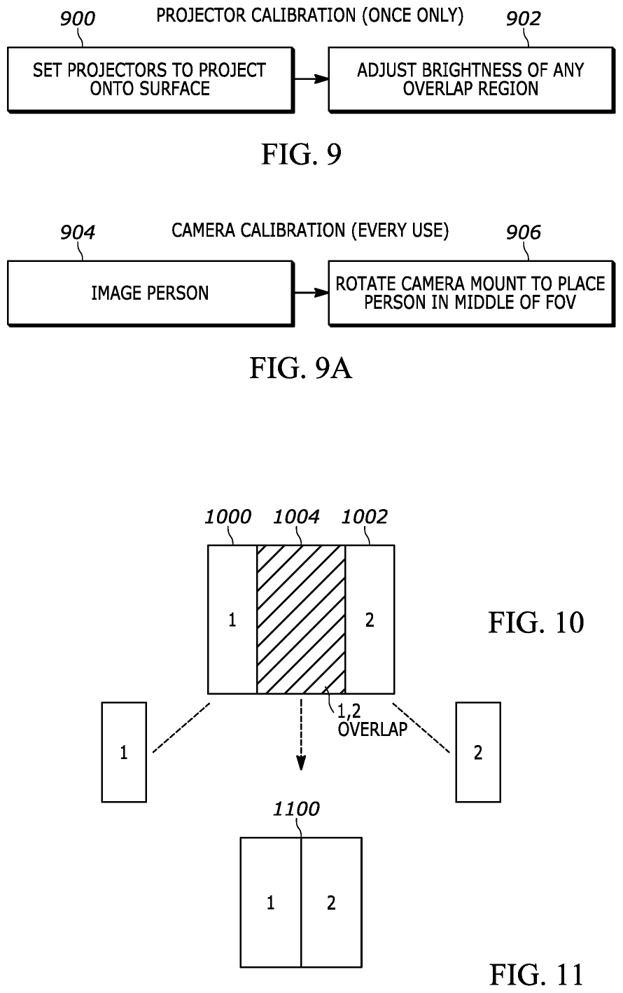

FIGS. 9 and 9A illustrate example logic that may be undertaken by any of the processors described herein. FIG. 9 illustrates projector calibration that may be executed once only on initial setup, whereas FIG. 9A illustrates camera calibration that may executed each time a person uses the system.

Commencing at block 900, the plural projectors are each set to project onto the surface. This may be done by rotating the respective housings (or by rotating any rotatable portions of the housings that are rotatable) as appropriate to direct the projector fields onto the surface. In confined areas, the projector fields may overlap if there is insufficient space, in which case the brightness of one or both projectors are adjusted in the overlap region as appropriate for optimum viewing. Or, the projection footprint or projected image of one or both projectors may be altered. The projectors may be controlled using signals from the sensors.

In larger spaces the projector fields are set not to overlap and may be set to be side-by-side. This affords more room for the person to move, and for more than a single person to move and be imaged within the detection area, e.g., to play a computer simulation together.

Commencing at block 904 in FIG. 9A, the person 16 is imaged using one or more of the sensors described herein. Moving to block 906, if desired the top segment 24 of the housing 12 may be rotated to turn the sensor(s) 22 toward the person such that, for example, the person is in the middle of the field of view (FOV) of the sensor(s). When the projector 26 is mounted on a segment of the housing that likewise is rotatable, the projector may be rotated toward the surface 32.

In addition, or alternatively to the above, audio source localization algorithms may also be used to localize the user. For example, the user may be prompted to say something during the initial configuration, or footsteps may be detected. These audio-based methods can be used with two or more microphones. The number of microphones and their positions influence the accuracy of the algorithms and can be tuned/designed for this use case.

FIGS. 10-12 illustrate principles from FIGS. 9 and 9A. As shown in FIG. 10, a projection “1” from a first housing “1” (such as any of the projection housings described herein) is in a region 1000 of the projection surface with no other projections, while a projection “2” from the second housing “2” is in a region 1002 of the projection surface with no other projections. However, both projections “1” and “2” overlap in the region 1004 between the regions 1000, 1002.

As shown in FIG. 11, the processor may eliminate the overlap by terminating each projection at the centerline 1100 of the overlap region. This may be done by shifting the projection footprints of the respective projectors, or by altering the brightness of the projectors, or by clipping each image from the projectors at the centerline 1100.

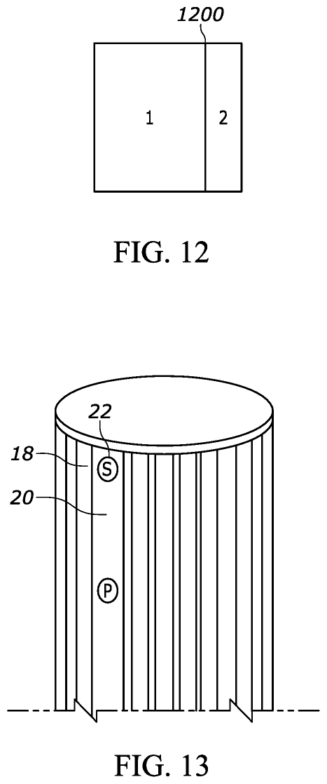

As an alternative, FIG. 12 illustrates that the entire original projection “1” is not altered, by the projection “2” is clipped at the right edge 1200 of the projection “1”. Other techniques for eliminating overlap between projected images may be used.

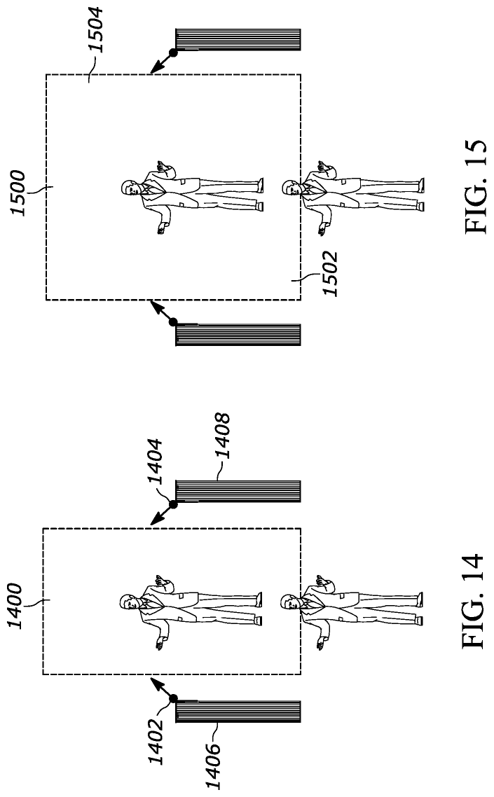

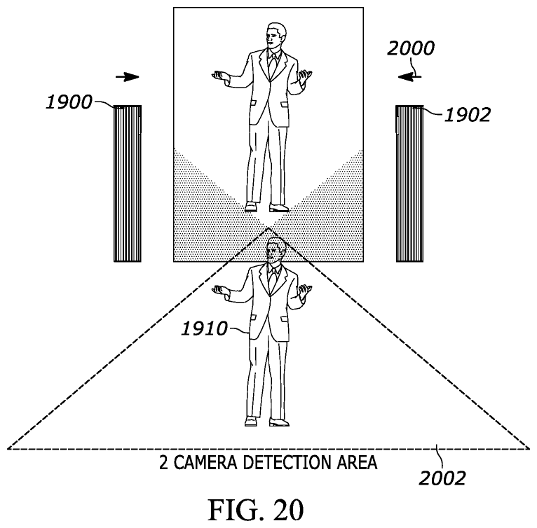

FIGS. 14-18 further illustrate projector calibration while FIGS. 19 and 20 further illustrate camera calibration. In FIG. 14 the projector fields or footprints have been set to completely overlap each other. The sensors can detect the projection area 1400. By completely overlapping, the projection brightness can be doubled. FIG. 14 illustrates left and right projectors 1402, 1404 on respective housings 1406, 1408

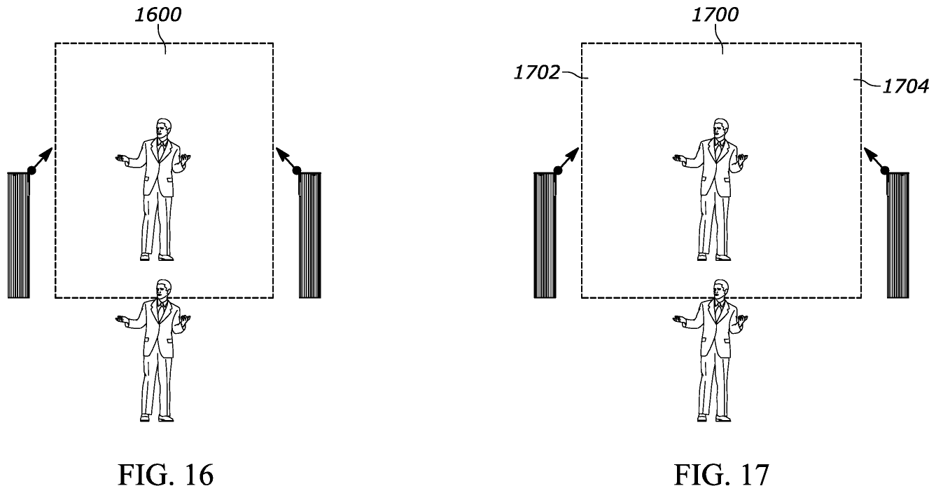

FIGS. 15 and 16 illustrate a setup in which the projector fields or footprints only partially overlap in an overlap area 1500 bounded by left and right non-overlapping projection regions 1502, 1504 from the respective left and right projectors. The sensors (cameras) can detect the projection area. In this case, the projectors may automatically adjust their brightness (e.g., based on camera images of the projected area) such that the brightness of the overlap area 1500 is the same as the brightness of the left and right projection regions to establish a uniform brightness projection area 1600 as shown in FIG. 16, In this way the projectors can be set at any desired distance from the projection surface (space permitting).

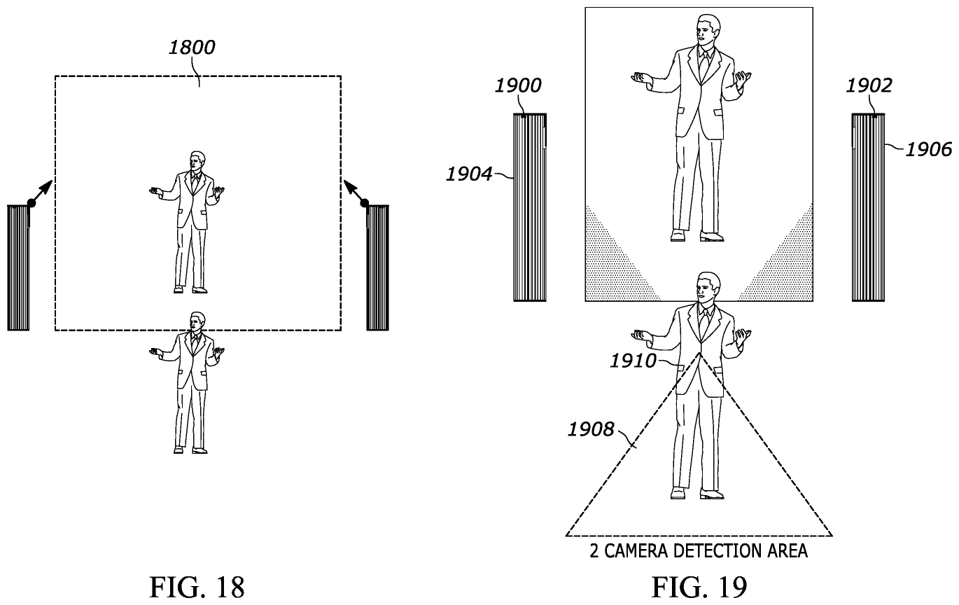

FIGS. 17 and 18 illustrate a setup in which the projector fields or footprints do not overlap at all, maximizing the projection area 1700 by placing projection areas 1702, 1704 from the left and right projectors, respectively side by side. FIG. 18 illustrates that the brightness of the projectors may be equalized to render a uniform brightness projection area 1800.

FIG. 19 illustrates that left and right cameras 1900, 1902 on left and right housings 1904, 1906 may initially have an overlap detection area 1908 that can only partially image a person 1910. FIG. 20 illustrates that the cameras 1900, 1902 can be rotated as indicated by the arrows 2000 to increase the overlap area into an enlarged overlap area 2002 that images the person 1910 completely, placing the person in the middle of the FOV of the overlap area. The rotation of the cameras may be automatically done based on images from the two cameras.

Thus, in an example embodiment, the assembly may include at least one processor programmed with instructions to identify that a projection from the first projector overlaps with a projection from the second projector, and responsive to identifying that the projection from the first projector overlaps with the projection from the second projector, alter at least one of the projections. In some examples plural projector housings may be provided that may be free standing and substantially identical to each other in shape and configuration at least in external physical appearance.

It will be appreciated that whilst present principals have been described with reference to some example embodiments, these are not intended to be limiting, and that various alternative arrangements may be used to implement the subject matter claimed herein.

1. An assembly, comprising:
at least a first projector housing;
at least a first sensor on the first projector housing to generate a signal representative of a person, wherein the first projector housing comprises plural elongated louvers oriented vertically; and
at least a first projector on the first projector housing and configured to project, based on the signal representative of a person, an avatar of the person onto a surface so that the person can view the avatar.

2. The assembly of claim 1, comprising:
at least a second projector housing; and
at least a second sensor on the second projector housing to generate a signal representative of the person.

3. (canceled)

4. The assembly of claim 1, wherein the first sensor is disposed between first and second louvers of the plural elongated louvers.

5. The assembly of claim 1, wherein the first sensor is disposed on at least one of the plural elongated louvers.

6. The assembly of claim 1, wherein the first sensor comprises at least one event-driven sensor (EDS).

7. The assembly of claim 1, wherein the first sensor comprises at least one red-green-blue (RGB) camera.

8. The assembly of claim 1, wherein the first sensor comprises at least one depth sensor.

9. The assembly of claim 1, wherein the first sensor comprises at least one microphone.

10. The assembly of claim 1, wherein the first sensor comprises at least one event-driven sensor (EDS) and the first projector housing supports at least one red-green-blue (RGB) camera, at least one speaker, and at least one microphone.

11. The assembly of claim 2, comprising at least one processor programmed with instructions to:
identify that a projection from the first projector overlaps with a projection from a second projector on the second housing; and
responsive to identifying that the projection from the first projector overlaps with the projection from the second projector, move at least one of the projections.

12. The assembly of claim 1, wherein the first sensor is disposed on a rotatable upper segment of the first projector housing.

13. An assembly, comprising:
at least a first projector housing;
at least a first projector on the first projector housing and configured to project images onto a surface; and
plural elongated louvers oriented parallel to each other on the first projector housing.

14. The assembly of claim 13, comprising:
at least a second projector housing;
at least a second projector on the second projector housing and configured to project images onto a surface; and
plural elongated louvers oriented parallel to each other on the second projector housing.

15. The assembly of claim 13, wherein the first projector housing comprises at least one sensor.

16. The assembly of claim 15, wherein the first sensor is disposed between first and second louvers of the plural elongated louvers.

17. The assembly of claim 15, wherein the first sensor is disposed on at least one of the plural elongated louvers.

18. The assembly of claim 15, wherein the first sensor comprises at least one sensor in the group of sensors that include event-driven sensors (EDS), red-green-blue (RGB) cameras, depth sensors, and microphones.

19. The assembly of claim 14, comprising at least one processor programmed with instructions to:
identify that a projection from the first projector overlaps with a projection from the second projector; and
responsive to identifying that the projection from the first projector overlaps with the projection from the second projector, move at least one of the projections.

20. A method, comprising:
imaging a person using at least one sensor on a housing, the sensor being juxtaposed with one or more vertical louvers of the housing; and
projecting an avatar of the person based on output of the sensor onto a surface using at least one projector on the housing.

21. (canceled)
